(19) United States
(12) Patent Application Publication
(10) Pub. No.: US 2022/0392478 A1
(43) Pub. Date: Dec. 8, 2022

(54) SPEECH ENHANCEMENT TECHNIQUES THAT MAINTAIN SPEECH OF NEAR-FIELD SPEAKERS

(71) Applicant: Cisco Technology, Inc., San Jose, CA (US)

(72) Inventors: Samer Lutfi Hijazi, San Jose, CA (US); Christopher Rowen, Santa Cruz, CA (US); Xuehong Mao, San Jose, CA (US); Ivana M. Balic, Studen (SW); Raul Alejandro Casas, Doylestown, PA (US); Savita Kini, Menlo Park, CA (US)

(21) Appl. No.: 17/471,979

(22) Filed: Sep. 10, 2021

Related U.S. Application Data
(60) Provisional application No. 63/197,783, filed on Jun. 7, 2021.

(51) Int. Cl. G10L 21/0364; H04M 3/56; G10L 21/0232; G10L 21/028

(52) U.S. Cl. CPC G10L 21/0364; H04M 3/568; G10L 21/0232; G10L 21/028; G10L 2021/02082

(57) ABSTRACT

An endpoint selectively enhances a captured audio signal based on an operating mode. The endpoint obtains an audio input signal of multiple users in a physical location. The audio input signal is captured by a microphone. The endpoint separates voice signals from the audio input signal and determines an operating mode for an audio output signal. The endpoint selectively adjusts each of the voice signals based on the operating mode to generate the audio output signal.

### CROSS REFERENCE TO RELATED APPLICATION

This application claims priority to U.S. Provisional Application No. 63/197,783, filed Jun. 7, 2021, the entirety of which is incorporated herein by reference.

### TECHNICAL FIELD

The present disclosure relates to noise reduction and speech enhancement.

### BACKGROUND

Speech enhancement involves removing unintelligible noise from desired speech/voice audio. Such techniques may be applied to rectify audio artifacts resulting from audio acquisition (e.g., microphones and room echo), communication channels (e.g., packet loss) and audio processing software (due to bandwidth limitations, saturation, etc.).

Current speech enhancement techniques are designed to preserve any intelligible speech and remove any audio that is not human speech (background noise). One problem with this scheme is in some communication sessions (voice or video calls or conferences), the distracting background noise is intelligible human speech generated by people surrounding the desired speaker. In such a scenario, current speech enhancement preserves and de-reverberates this background competing talker, often making it even more annoying.

### BRIEF DESCRIPTION OF THE DRAWINGS

FIG. 1 is a system diagram showing an endpoint capturing audio from a space to accommodate different modes of speech enhancement, according to an example embodiment.

FIG. 2 is a high-level system diagram showing a plurality of different signal processing paths to accommodate different modes of speech enhancement, according to an example embodiment.

FIG. 3 is a diagram depicting a processor preparing training data used in train an audio processing system, according to an example embodiment.

FIG. 4 is a diagram depicting a model training process that may be used in an audio processing system, according to an example embodiment.

FIG. 5 is a diagram depicting a model inference process for a single-talker mode of an audio processing system, according to an example embodiment.

FIGS. 6A and 6B are diagrams depicting processing for a multi-talker mode of an audio processing system, according to an example embodiment.

FIG. 7 is a flowchart illustrating operations performed at an endpoint in an audio processing system to selectively enhance or suppress voice signals based on an operating mode, according to an example embodiment.

FIG. 8 is a flowchart illustrating operations performed at an endpoint in an audio processing system to process voice signals for different operating modes, according to an example embodiment.

FIG. 9 is a hardware block diagram of a computing device that may perform functions associated with any combination of operations discussed herein in connection with the techniques depicted in FIGS. 1-8.

### DESCRIPTION OF EXAMPLE EMBODIMENTS

### Overview

A computer-implemented method is provided for an endpoint to selectively enhance a captured audio signal based on an operating mode. The method includes obtaining an audio input signal of a plurality of users in a physical location. The audio input signal is captured by a microphone. The method also includes separating a plurality of voice signals from the audio input signal and determining an operating mode for an audio output signal. The method further includes selectively adjusting each of the plurality of voice signals based on the operating mode to generate the audio output signal.

### Example Embodiments

Presented herein is a speech/audio signal processor for performing noise reduction in a conferencing endpoint (e.g., teleconferencing endpoint, video conferencing endpoint, online conferencing endpoint, etc. The signal processor may have multiple signal processing paths for different operating modes. A signal processing path (or an operating mode) may be selected based on an intended application for the audio. For instance, the speech signal processor may be used to remove undesired background talkers and/or to equalize audio level of all desired talkers. The specific operating mode may be selected by a user or automatically selected by the system based on available feedback regarding the intended application.

Different operating modes may be designed to enable different applications of the audio processing system. One application of the system may be to recognize the presence of different groups of talkers at different distances from a conference endpoint and apply specific processing to each of those groups. More specifically, one application may be to identify and separate primary voice signals from secondary voice signals and selectively increase/decrease audio levels of the voice signals based on the group to which the voice signal belongs. A user of a conferencing system may also selectively preserve/enhance specific audio signals while simultaneously attenuating/removing other audio signals. As used herein, voice signals may also be called speech signals and refer to audio signals produced by a user's voice.

The audio processing system may select an operating mode automatically based on acoustic characteristics (e.g., speech, music, background noise), or visual characteristics captured by the system (e.g., detecting distances of users or user groups). Additionally, a user (e.g., a participant in a conference call or the conferencing system designer) may provide input into the selection of the operating mode.

To deploy a speech enhancement system, the system designer has a range of choices of when and how to tune the output speech to different use cases. In some cases, the desire to eliminate secondary talker speech is inherent in the purpose of the target device. For example, a headset, ear buds, or other wearable devices may always want to focus on the speech of the wearer, so other speech should always be suppressed. Similarly, a conference endpoint in a conference room may want to capture speech uniformly from a roomful of users, where inevitably some talkers are more distant (softer and more reverberant) than others.

In other cases, the preference for focusing on just the primary talker or on a group of talkers at different distances may vary as the situation changes. For example, a laptop may be used for audio conferencing in both a single user mode or a group mode. A smartphone may be used by a single user when held close to the user's ear, or the smartphone may be used by a group of users when placed on the table with speaker turned on. A microphone used in a solo performance may benefit from single voice mode but may need multiple voice support when used by an ensemble of performers. In these situations, the choice of mode may be explicit, and may be exposed in the interface of the device or the software as a user input (e.g., a switch, an option configuration in a graphics user interface associated with the device performing the audio processing, or by remote configuration from network-connected software).

In some cases, the preferred mode can be inferred dynamically from the immediate speech context. As one example, the system may detect that only a single talker is active over an extended time and choose the mode in which secondary speakers are suppressed, to prevent accidental interruptions. However, the system may also be able to handle a secondary talker entering the conversation unexpectedly. When a background voice persists for an extended period, then the mode may automatically switch to a multi-talker mode until the secondary talkers disappear for an extended period. A more refined method may consider the pattern of speech between the primary talker and secondary talkers. If the different talkers are part of the same conversation, they will generally not speak over one another—they will alternate. By contrast, if the secondary talkers are mere interferers, they probably will not wait for gaps in the primary talker's flow to start speaking. The presence or absence of speech overlap may serve as a useful mechanism for automatically switching between a background talker suppression model and an enhancement mode. Video inputs may also provide useful clues for selecting the mode. A secondary talker in view of a laptop's camera, for example, is more likely to be an intended participant in an audio recording or transmission than a talker who is off camera, perhaps speaking from an adjoining room.

Unlike some existing solutions, the single-talker mode techniques presented herein do not require any speaker enrollment and automatically classifies primary and secondary talkers. No user interaction is needed.

In some examples of the multi-talker mode presented herein, it is assumed that more than one talker could be in the audio space and that the speech levels of the different talkers are different, in general. A remote listener may find the audio more pleasant when the sound levels of all talkers are perceived in the same way. A related issue occurs when mixing audio signals from different devices into a single audio stream. The multi-talker mode described herein performs speech leveling for different talkers, suppresses background noise, and removes reverberation from the speech signals.

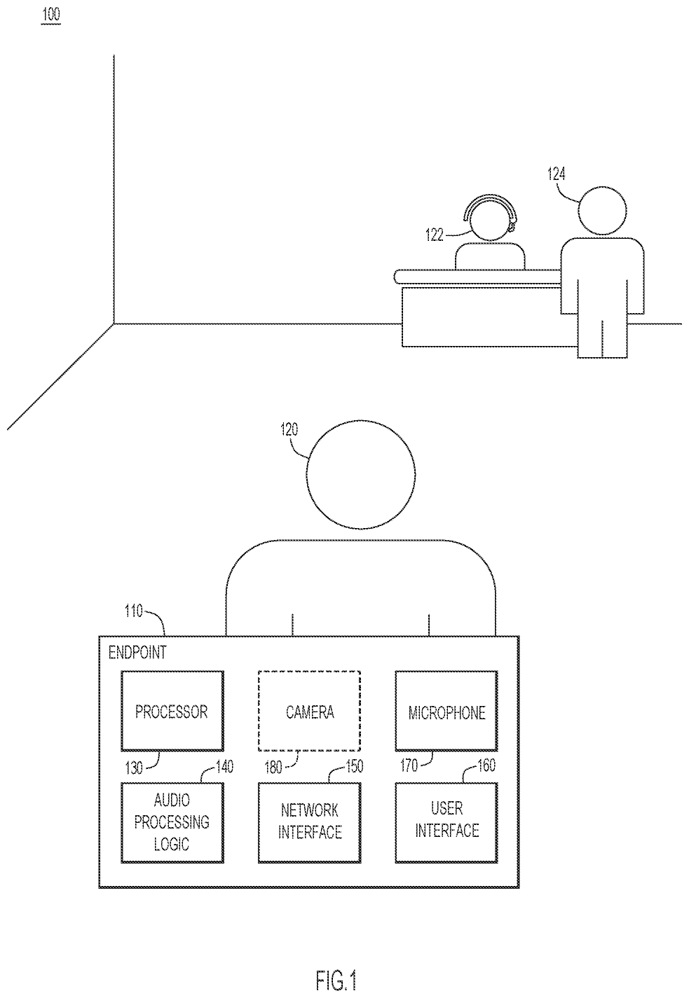

Referring now to FIG. 1, a simplified diagram shows an audio processing system operating in a potentially noisy environment 100. The system includes an endpoint 110 that is relatively close to a user 120. Other users 122 and 124 in the environment 100 are further from the endpoint 110. In one example, the endpoint 110 may be a personal computer (e.g., laptop, desktop computer, thin client, etc.), a mobile device (e.g., smartphone), or a telepresence endpoint. In another example, the endpoint 110 may be connected to a remote endpoint in an online conference.

The endpoint 110 includes a processor 130, audio processing logic 140, a network interface 150, a user interface 160, a microphone 170, and optionally a camera 180. The audio processing logic 140 is configured to enable the processor 130 to perform the audio processing techniques described herein. The network interface 150 is configured to communicate with other computing devices, such as other endpoint devices. The user interface 160 provides input from the user 120 to the endpoint 110 and provides output from the endpoint 110 to the user 120. The microphone 170 captures audio from the environment 100, such as speech from user 120, background speech from user 122 and user 124, and/or background environmental noise. The camera 180 is configured to capture video of at least some portion of the environment 100, such as the user 120.

In one example, the user 120 may use the endpoint 110 to participate in an online conference or a telephone conversation with a remote endpoint. The audio processing logic 140 differentiates the speech of the user 120 from the speech of the user 122 and/or the user 124 to ensure that only the intended audio is provided for the online conference or telephone conversation. In one mode, the user 122 and the user 124 may not be part of the conversation in the online conference, and their respective speech audio is minimized. In another mode, the user 122 and/or the user 124 may be part of the conversation, and their speech audio is included in the audio for the online conference. Additionally, the audio level of the speech from users (e.g., user 122 and/or user 124) who are further away may be enhanced to improve the audio quality for the participants of the online conference. The audio processing logic 140 may also detect and potentially remove non-speech audio that may interfere with the audio for the online conference.

The speech of one user may be differentiated from the speech of other users through different methods of automatic classification. In one example, the speech of secondary talkers (e.g., user 122 and user 124) may be differentiated from the speech of a primary talker (e.g., user 120) based on speech analysis of two audio characteristics: speech energy and reverberation level. In a typical environment, the distance between the primary talker (e.g., user 120) and the microphone 170 is less than 1 meter, and the background talkers (e.g., user 122 and user 124) may be at least 2-4 meters from the microphone 170. If the speech power of the primary talker and the secondary talkers are approximately the same, the received power at the microphone from the respective direct paths may differ by a factor of 4-16. In general, a primary talker will provide near field audio that is dominated by the direct audio path from the primary talker to the microphone, with only modest contribution from longer, indirect paths due to reflections within the environment. However, secondary talkers at a greater distance provide audio with reflected paths providing a relatively larger fraction of the total power received at the microphone 170 in most indoor environments. Differences in room geometry and surface materials in the environment 100 may have a significant effect on the degree of reverberation, but some amount of reverberation is challenging to avoid in the environment 100.

In another example, the speech of different users may be differentiated based on the location of the users in the environment and/or relative location of users with respect to the location of the microphone 170. If the endpoint 110 includes a camera 180, the location and distance of secondary talkers (e.g., user 122 and user 124) relative to a primary talker (e.g., user 120) may be estimated from video cues. Additionally, multiple microphone capture techniques may enable triangulation to determine the location of the users within the environment and assist in refining the differentiation of primary talker audio from secondary talker audio, that is, to assist in separating a plurality of voice audio/signals.

In a further example, the speech of primary talkers and secondary talkers may be differentiated based on participation in a conversation. The endpoint 110 may analyze audio and/or video from secondary talkers for context of a conversation to determine their participation in an online conference. For instance, video from camera 180 may be assessed to determine whether secondary talkers are located within the video frame. Additionally, the pose of the secondary talkers (e.g., facing toward or away from the camera) and/or lip movement (e.g., synchronized to speech of online conference participants) may be tracked to differentiate secondary talkers from primary talkers. Speech audio activity in an online conference may be similarly assessed to differentiate secondary talkers from primary talkers. The endpoint 110 may also use natural language processing to determine the relevance of speech audio from secondary talkers to the conversation in an online conference through the endpoint 110.

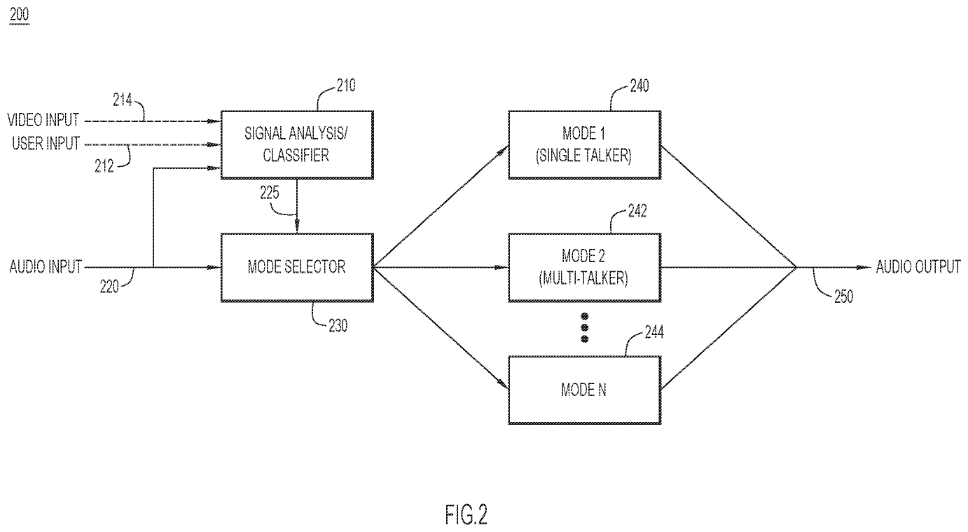

Referring now to FIG. 2, a simplified block diagram illustrates an example flow 200 of the audio processing performed by the processor 130 using the audio processing logic 140. The audio input 210 is recorded from the audio environment and may include audio from multiple users as well as background environmental noise. The audio input 210, along with an optional user input 212 and video input 214, is provided to a signal analysis/classifier module 220. The module 220 provides a selection signal 225 to a mode selector module 230 based on the audio input 210, as well as the user input 212 and video input 214.

The mode selector module 230 provides the audio input 210 to one of a plurality of processing modes, such as mode 240, mode 242, or mode 244, based on the selection signal 225. In one example, the mode 240 is a single talker mode that suppresses all audio other than speech from the primary talker. In another example, the mode 242 is a multi-talker mode that suppresses background noise, but keeps speech audio from both primary talkers and secondary talkers. The mode 242 may enhance the speech audio from secondary talkers to match the level of the speech audio from the primary talker. Whichever mode (e.g., mode 240, 242, or 244) is selected by the mode selector module 230 processes the audio input 210 and provides the audio output 250.

In another example, each mode 240, 242, 244 may include a neural network that is trained to differentiate audio that is coming from different talkers. There is a variety of methods available for distance analysis and for reverberation analysis to differentiate near-field talkers (e.g., user 120) from far-field talkers (e.g., user 122 and user 124). Near-field talkers may be those persons involved in a call or communication session that are, for example, between 0.5 m to 0.8 m from the microphone. Far-field talkers may be those persons that are, for example, 2 m or more from the microphone.

Training neural networks with a wide diversity of talker types, talker distances to microphones, room acoustic scenarios, vocabulary, and environmental noise effectively enables the neural networks to differentiate speech from different acoustic scenarios (e.g., distance, reverberation level). Training the neural networks with a diverse set of talker types also enables the neural network to enhance or to suppress a given category of speaker (e.g., speaker of interest vs. interferer) according to the goals for that particular neural network. The goals for each neural network may be established relative to the target output audio stream. For instance, in one scenario (or mode), the target output audio may thoroughly exclude a secondary talker's speech. In another scenario/mode, the neural network may be trained to include a secondary talker's speech in the target output audio, but maintain the secondary talker's audio at the original amplitude. In a third scenario/mode, the neural network may be trained to include secondary talker's speech in the target output audio, but raise the power of the secondary talker's audio to more closely match the power of the primary talker's audio. This brings the apparent speech volume to a more uniform level for the comfort and understanding of listeners.

Each neural network may also be trained to reduce or remove the environmental noise and/or reverberation found in the audio stream to improve overall comprehensibility.

In the multi-talker scenario/mode, the normalization of talker output levels may be done directly in the trained neural network or may be performed by the combination of automatic gain control (AGC) signal filtering and a neural network. This AGC could be performed either at the input of the neural network or at the output of the neural network. If the AGC is performed before the audio input signal goes into the neural network, the AGC module adjusts gain based on the speech component inside the entire audio input signal, which may include a mixture of noise and speech. If the AGC module adjust gain based only on portions of the audio input signal identified as speech, there may be situations where noise is amplified excessively or situations where speech component is not amplified sufficiently because a noise audio signal inside the mixture is mistaken as speech. Excessive noise amplification may make it more difficult for the downstream processing, such as the neural network, to achieve the desired consistency in noise removal. On the other hand, if the speech is not amplified to the target level, there may not be consistency in the speech output levels.

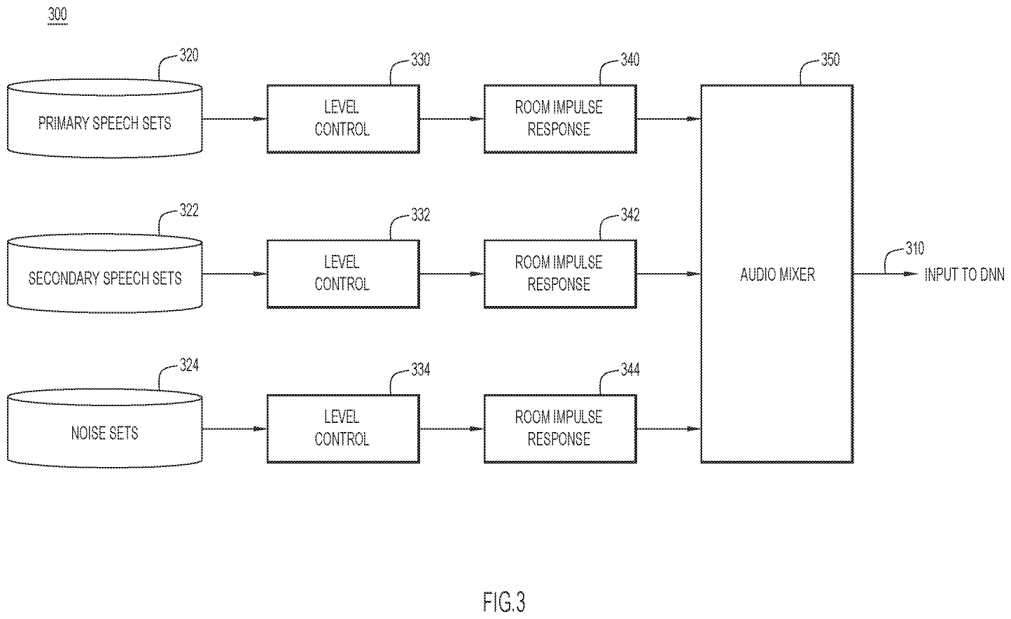

Referring now to FIG. 3, a simplified block diagram illustrates a data preparation system 300 to train a neural network to differentiate speech between different groups of talkers as well as other environmental noise. The input signal 310 to the Deep Neural Network (DNN) is a combination of (i) primary speech sets 320 from one group of talkers (e.g., the speech of a primary talker), (ii) secondary speech sets 322 from another group of talkers (e.g., the speech of potentially interfering secondary talkers), and (iii) noise sets 324 of other additive noise (e.g., background environmental noise). The level of the primary speech sets 320 is controlled by a level control module 330 before applying a Room Impulse Response (RIR) module 340 to reverberate the primary speech sets 320. Similarly, the level of secondary speech sets 322 and noise sets 324 may be controlled by level control modules 332 and 334, respectively, before applying RIR modules 342 and 344, respectively, to reverberate the secondary speech sets 322 and noise sets 324 accordingly. An audio mixer 350 combines the processed audio signals from each branch of data sets to generate the input signal 310 to train the neural network.

In one example, the primary speech sets 320 and the secondary speech sets 322 used to train the neural network may start as the same set of audio signals, with the difference between primary talker speech and secondary audio speech being caused by the level control modules 330 and 332 and the RIR modules 340 and 342.

In another example, the RIR modules 340, 342, and 344 may be normalized to change the reverberation level of the audio signals without changing the power level of the signal. The level of the signals is separately controlled by the level control modules 330, 332, and 334. By this design, the signal energy and reverberation level in the input signal 310 may be controlled and the neural network model may be trained on largely diversified scenarios. For instance, different neural network modes may be trained with different mixtures of primary speech data, secondary speech data, and noise data. Additionally, the different neural network modes may be trained toward different goals to produce different output signals, such as a single talker mode being trained to suppress secondary talkers and noise.

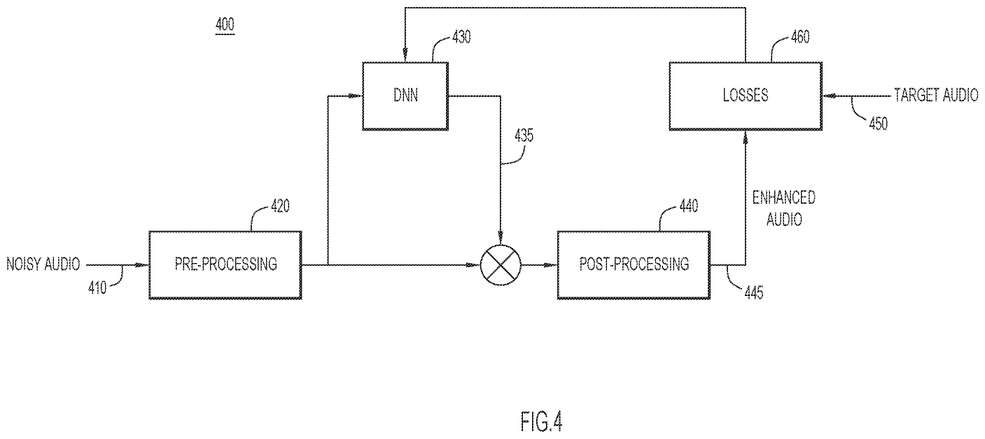

Referring now to FIG. 4, a simplified block diagram shows a training system 400 for training a DNN that is capable of learning different outcomes according to the training process and target choices. The training system 400 starts with a noisy audio signal 410 being provided to a pre-processing module 420. In one example, the noisy audio signal 410 may be constructed from primary talker audio, secondary talker audio, and background noise audio, all of which has been mixed as described with respect to FIG. 3. The pre-processing module 420 may further prepare the noisy audio signal 410 for processing by a DNN 430. For instance, the pre-processing module 420 may segment or filter the noisy audio signal 410 to format the noisy audio signal appropriately for input to the DNN 430.

After the DNN 430 processes the output from the pre-processing module 420 to determine inferences 435 from the audio signal, the inferences 435 are applied to the noisy audio signal 410 and provided to a post-processing module 440. In one example, the inferences 435 may be provided as a mask to apply to the pre-processed signal from the pre-processing module 420. In another example, the post-processing module 440 may smooth transitions between segments of the audio signal. The post-processing module 440 generates an enhanced audio signal 445, which is compared to a target audio signal 450 to determine the losses 460. The losses 460 are provided to the DNN 430 to refine the coefficients used by the DNN 430.

The DNN 430 is capable of learning different outcomes according to the training process and choices for target audio signal 450. In one example, the target audio signal 450 is a ground truth audio signal that is constructed from a portion of the audio data that was used to generate the noisy audio signal 410. For instance, to train the DNN 430 in a single talker mode, the target audio signal 450 may be constructed from the primary talker audio without the secondary talker audio and without the background noise audio. To train the DNN 430 for a multi-talker mode, the target audio signal 450 may be constructed from primary talker audio and the secondary talker audio without the background noise audio.

To train the DNN 430 in a single-talker mode, the noisy audio signal 410 (e.g., a mixture of the speech of interest, interfering speech, and background noises) is fed into the neural network model. To train the model to suppress all noises as well as the interference speech, the ground truth is set to the speech of interest without applying an RIR module (e.g., RIR module 340 as shown in FIG. 3). The goal of the single-talker mode is to minimize undesired background talkers, noises, and reverberation. As a result, the model may provide a 3-fold improvement: removing background noise, suppressing secondary talkers, and de-reverberation. Single-talker mode may be useful for home offices, call centers, public locations, co-working spaces, or shared workspaces. In another example, multiple people may be considered as the primary talkers in the single-talker mode. For instance, multiple people may contribute to the near-field audio, which is enhanced, over the far-field audio, which is suppressed. As a specific example, a conference setting may include a panel of presenters as the primary talkers with each presenter in the near-field of a microphone, while audio from the audience is in the far-field of the presenters' microphones, and is suppressed.

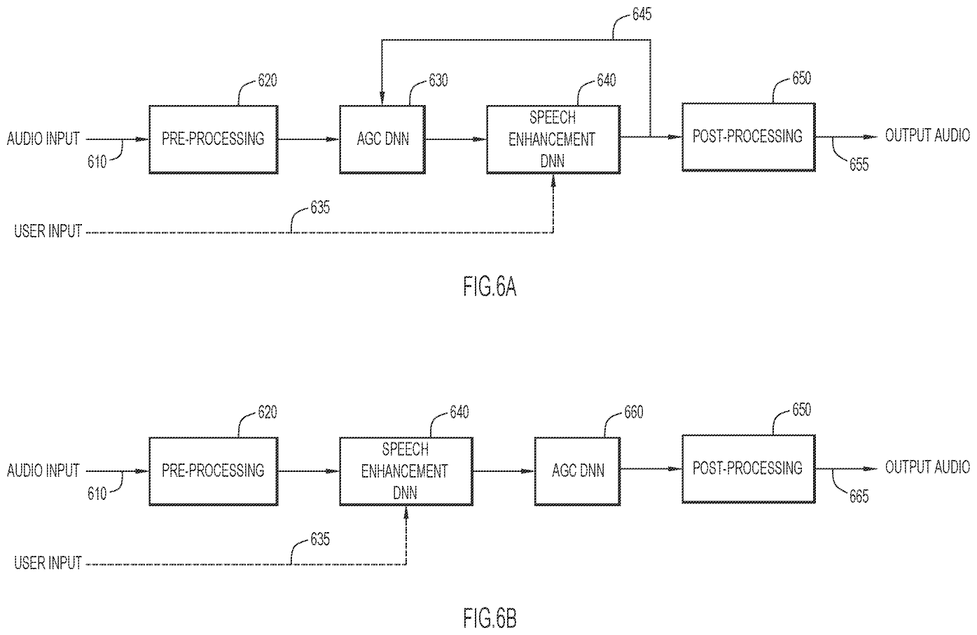

In another example, the DNN 430 may be trained for a multi-talker mode with the goal to enhance the speech of all talkers present in the audio space (i.e., both near-field audio and far-field audio) and to equalize the power levels of the different speech signals. In other words, the voice audio of the secondary talkers (e.g., far-field audio in the background) is retained and the power levels are equalized with the voice audio of the primary talker. For instance, the microphone placement within conference rooms or huddle spaces may place different participants in a conversation in different zones (e.g., near-field or far-field) within the audio space. Two alternative methods for equalizing speech levels in a multi-talker mode are discussed with respect to FIG. 6A and FIG. 6B, described below.

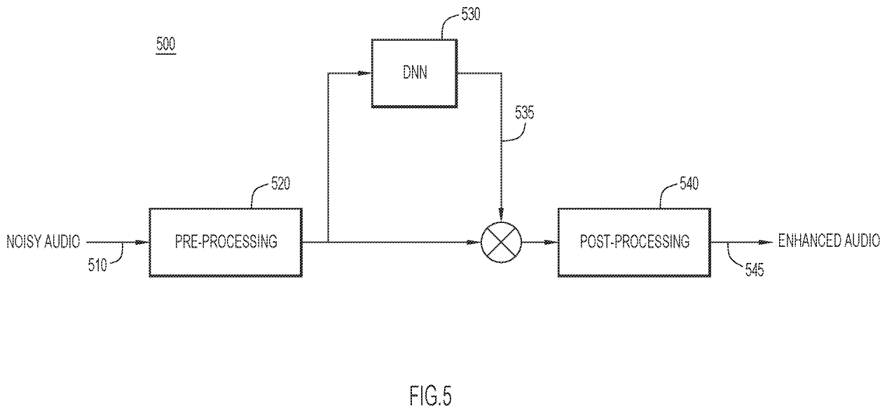

Referring now to FIG. 5, a simplified block diagram illustrates an implementation 500 of a neural network model that has been trained in a single-talker mode to isolate and enhance a primary talker signal and suppress secondary talker signals and background noise signals. The implementation 500 provides a noisy audio signal 510 to a pre-processing module 520, which prepares the noisy audio signal 510 for processing by a DNN 530. For instance, the pre-processing module 520 may segment or filter the noisy audio signal 510 to format the noisy audio signal 510 appropriately for input to the DNN 530.

After the DNN 530 processes the output from the pre-processing module 520 to determine inferences 535 from the audio signal, the inferences 535 are applied to the noisy signal 510 and provided to a post-processing module 540. In one example, the post-processing module 540 may smooth transitions between segments of the audio signal. The post-processing module 540 generates an enhanced audio signal 545, which includes the de-reverberated primary talker speech audio and suppresses any secondary talker's speech as well as any background environmental noise. In one example, the implementation 500 does not require any Automatic Gain Correction (AGC) in either the pre-processing module 520 or the post-processing module 540, since the DNN 530 is trained to keep only the primary talker's speech of interest.

Referring now to FIG. 6A and FIG. 6B, simplified block diagrams illustrate implementations of neural network models that have been trained in a multi-talker mode, e.g., to capture and equalize all of the speech in an audio space. FIG. 6A illustrates an implementation in which AGC is performed before the speech enhancement block, e.g., before the neural network model determines inferences about individual speech or noise signals. FIG. 6B illustrates an implementation in which AGC is performed after the speech enhancement block, e.g., after the neural network has made inferences about individual speech or noise signals.

In the multi-talker mode of the neural network model shown in FIG. 6A, an audio input 610 is provided to a pre-processing module 620 which prepares the audio input 610 for processing by the neural network model. For instance, the pre-processing module 620 may segment or filter the audio input 610 to format the audio input 610 appropriately for input to the neural network model. An AGC module 630 takes the pre-processed audio signal and adjusts the power level of the entire audio signal. In one example, the AGC module may be a neural network (e.g., a DNN).

A speech enhancement module (DNN) 640 takes an input of the audio signal from the AGC module 630, identifies speech audio from different talkers and background noise, and selectively enhances or suppresses individual audio portions based on the training of the neural network in the speech enhancement module 640. In one example, the speech enhancement module 640 may select which portions of the audio signal to enhance or suppress based on an optional user input 635. For instance, the user input 635 may include an indication of whether to equalize (or balance) the level of the secondary talker's audio signal with the level of the primary talker's audio signal to ensure that each of the voice signals make substantially equal contributions to the enhanced audio signal 655. The speech enhancement module 640 may also provide feedback 645 to the AGC module 630. For instance, the speech enhancement module 640 may determine that the secondary talker's audio signal may be better separated from the background noise signal if the level of the entire audio signal is raised. In other words, when the operating mode is a multi-talker mode, selective adjustment is made of each of the plurality of voice signals by balancing an audio level of a plurality of voice signals to generate substantially equal contributions from each of the plurality of voice signals to an audio output signal.

After enhancing and suppressing portions of the audio signal (e.g., primary talker signals, secondary talkers signals, and/or background noise signals), the speech enhancement module 640 provides an output audio signal to a post-processing module 650. In one example, the post-processing module 650 may smooth transitions between segments of the audio signal. The post-processing module 650 generates an enhanced audio signal 655, which includes the de-reverberated speech audio from both primary talkers and secondary talkers without background environmental noise.

In the multi-talker mode of the neural network model shown in FIG. 6B, an audio input 610 is provided to a pre-processing module 620 which prepares the audio input 610 for processing by the neural network model. For instance, the pre-processing module 620 may segment or filter the audio input 610 to format the audio input 610 appropriately for input to the neural network model.

The speech enhancement module 640 takes the pre-processed audio signal directly from the pre-processing module 620 and identifies speech audio from different talkers and background noise. The speech enhancement module 640 selectively enhances or suppresses individual audio portions based on the training of the neural network in the speech enhancement module 640. In one example, the speech enhancement module 640 may select which portions of the audio signal to enhance or suppress based on an optional user input 635. For instance, the user input 635 may include an indication of whether to equalize the level of the secondary talker's audio signal with the level of the primary talker's audio signal to ensure that each of the voice signals make substantially equal contributions to the enhanced audio signal 665.

An AGC module 660 takes the enhanced audio signal from the speech enhancement module 640 and adjusts the power level of the enhanced audio signal. In one example, the AGC module may be a neural network (e.g., a DNN). The AGC module 660 provides an output audio signal to a post-processing module 650. In one example, the post-processing module 650 may smooth transitions between segments of the audio signal. The post-processing module 650 generates an enhanced audio signal 665, which includes the de-reverberated speech audio from both primary talkers and secondary talkers without background environmental noise.

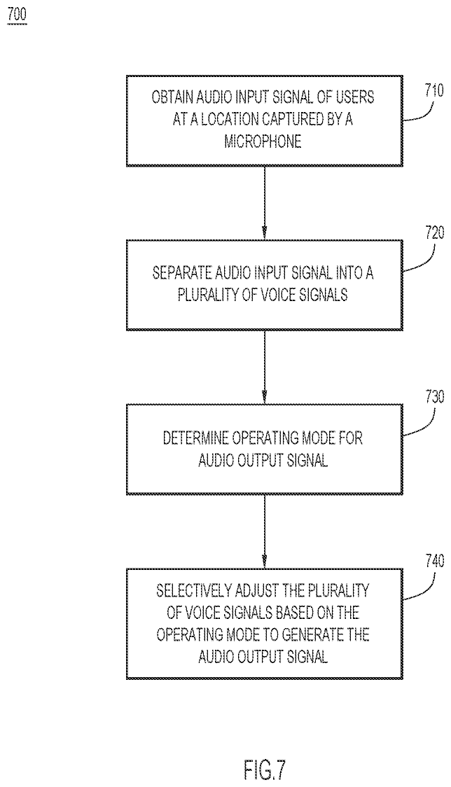

Referring now to FIG. 7, a flowchart illustrates operations performed by a conference endpoint (e.g., endpoint 110 referred to above in connection with FIG. 1) in a process 700 to selectively adjust audio signals based on an operating mode of the endpoint. At 710 the endpoint obtains an audio input signal of a plurality of users at a location captured by a microphone. In one example, the microphone is a part of the endpoint or directly connected to the endpoint. In another example, the plurality of users may be at varying distances and places within the physical location of the audio space captured by the microphone.

At 720, the endpoint separates a plurality of voice signals from the audio input signal. In one example, the endpoint may also separate out a signal of background environmental noise that is not a voice signal. In another example, the endpoint may separate the plurality of voice signals with a neural network based on at least the direct power and the reverberated power of each voice signal. At 730, the endpoint determines an operating mode for an audio output signal. In one example, the operating mode may be a single-talker mode, a multi-talker mode, a conference room mode, or a panel conference mode.

At 740, the endpoint selectively adjusts each of the plurality of voice signals based on the operating mode to generate the audio output signal. In one example, a single talker mode may cause the endpoint to selectively enhance near-field voice signals and suppress far-field voice signals and background environmental noise. In another example, a multi-talker mode may cause the endpoint to preserve voice signals of both near-field and far-field voice signals and suppress background environmental noise. In a further example, a conference room mode may be a multi-talker mode that causes the endpoint to substantially equalize all of the voice signals in power level. In yet another example, a panel conference mode may cause the endpoint to enhance user selected voice signals (e.g., the conference panel) and suppress other voice signals (e.g., audience members. Additionally, any of the operating modes may cause the endpoint to de-reverberate some or all of the voice signals for the output audio signal.

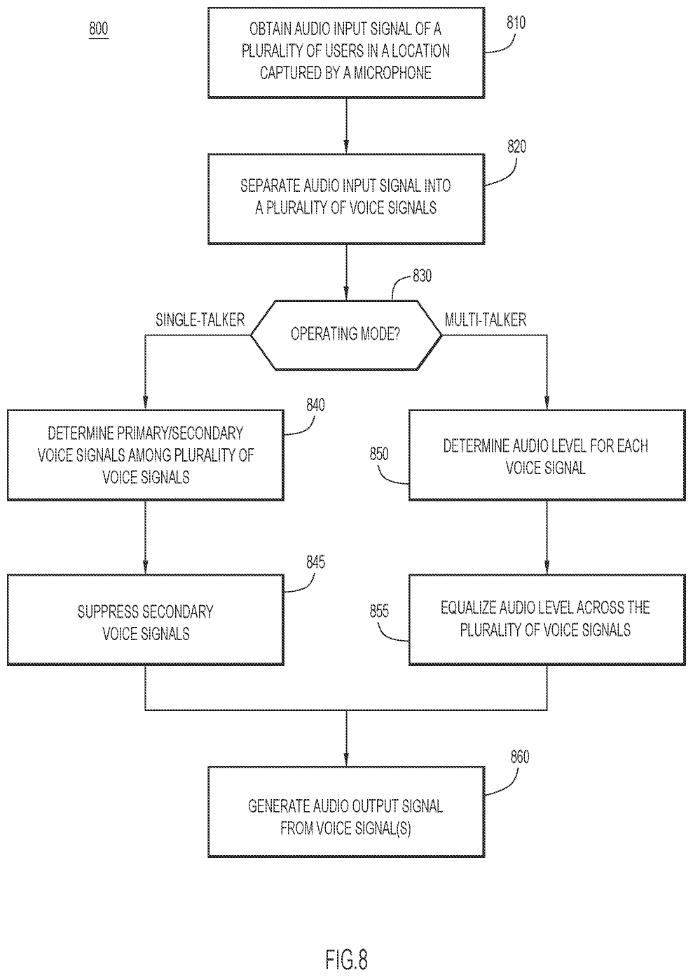

Referring now to FIG. 8, a flowchart illustrates operations performed by a conference endpoint (e.g., endpoint 110 referred to above in connection with FIG. 1) in a process 800 to select an operating mode and generate an audio output signal based on an operating mode of the endpoint. At 810, the endpoint obtains an audio input signal of a plurality of users at a location captured by a microphone. In one example, the plurality of users may be at varying distances and places within the physical location of the audio space captured by the microphone. In another example, the microphone may include a plurality of microphones.

At 820, the endpoint separates the audio input signal into a plurality of voice signals. In one example, the endpoint may also separate out a signal of background environmental noise that is not a voice signal. In another example, the endpoint may separate the plurality of voice signals with a neural network based on at least the direct power and the reverberated power of each voice signal. At 830, the endpoint determines whether to process the voice signals in a single talker mode or a multi-talker mode. In one example, the endpoint may determine the operating mode based on one or more dynamic cues, such as video input, conversational participation, and/or direct user input. In another example, the endpoint may change the operating mode during an audio session based on a change in the dynamic cues.

If the endpoint selects a single-talker mode at 830, then the endpoint determines which voice signals a primary voice signals and which voice signals are secondary voice signals (i.e., interfering voice signals) at 840. In one example, the endpoint may select one or more primary voice signals based on one or more cues including reverberation of the audio signal, natural language processing of conversational relevance, appearance and/or location in a video frame captured by a camera associated with the audio space, and/or direct user input. In another example, the endpoint may differentiate between primary and secondary voice signals by using a neural network trained in a single-talker mode. At 845, the endpoint suppresses all of the secondary voices. In one example, the endpoint may also enhance the primary voice signal (e.g., by removing reverberation) and/or suppress background environmental noise signals.

If the endpoint selects a multi-talker mode at 830, then the endpoint determines an audio level for each voice signal at 850. In one example, voice signals from users further from the microphone may be recorded with a lower audio level than voice signals from users positioned closer to the microphone. At 855, the endpoint equalizes the audio level across the plurality of voice signals to ensure that each voice signal is reproduced at substantially the same volume for the ease and comfort of listeners. In one example, the endpoint may equalize the voice signals by using a neural network trained in a multi-talker mode.

At 860, the endpoint generates an output audio single from the remaining voice signals, i.e., voice signals that have not been suppressed from the single-talker mode or the equalized voice signals from the multi-talker mode. In one example, the endpoint may employ a post-processing module (e.g., to smooth transitions) in the generation of the audio output signal.

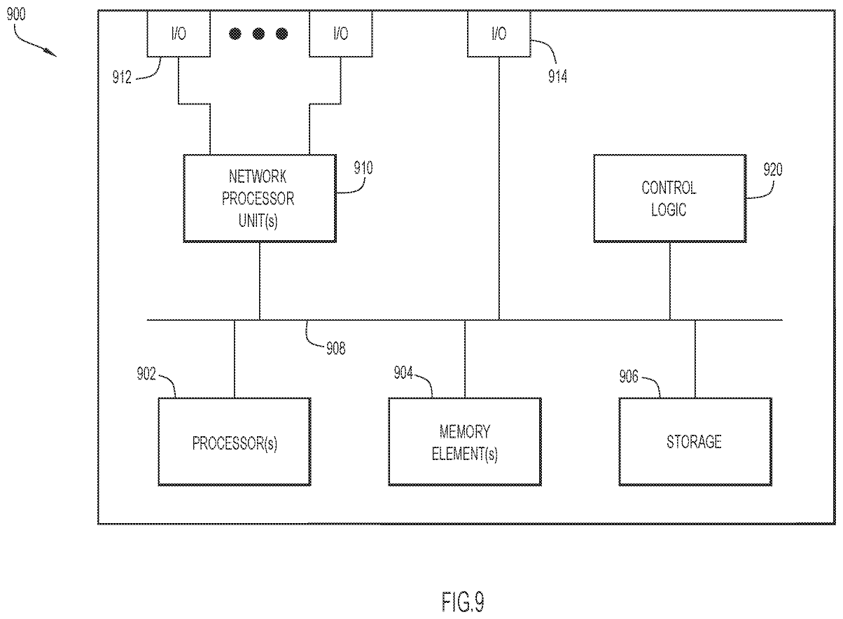

Referring to FIG. 9, FIG. 9 illustrates a hardware block diagram of a computing device 900 that may perform functions associated with operations discussed herein in connection with the techniques depicted in FIGS. 1-5, 6A, 6B, 7, and 8. In various embodiments, a computing device, such as computing device 900 or any combination of computing devices 900, may be configured as any entity/entities as discussed for the techniques depicted in connection with FIGS. 1-5, 6A, 6B, 7, and 8 in order to perform operations of the various techniques discussed herein.

In at least one embodiment, the computing device 900 may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, and/or any other I/O port(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, entities for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein provide for speech enhancement of audio signal that varies based on a selected operating mode. Different operating modes may differentiate voice signals based on speech level and reverberation, and enhance or suppress different voice signals based on the operating mode. A single-talker mode may enhance near-field voice signals and suppresses far-field voice signals. A multi-talker mode may enhance far-field voice signals by using a fast acting automatic gain control module to substantially equalize the level of all of the voice signals captured by a microphone.

In one form, a method is provided for an endpoint to selectively enhance a captured audio signal based on an operating mode. The method includes obtaining an audio input signal of a plurality of users in a physical location. The audio input signal is captured by a microphone. The method also includes separating a plurality of voice signals from the audio input signal and determining an operating mode for an audio output signal. The method further includes selectively adjusting each of the plurality of voice signals based on the operating mode to generate the audio output signal.

In another form, a system comprising a microphone, a network interface, and a processor is provided. The microphone is configured to capture audio. The network interface is configured to communicate with a plurality of computing devices in a wireless network system. The processor is coupled to the network interface and the microphone, and configured to obtain an audio input signal of a plurality of users in a physical location. The audio input signal is captured by the microphone. The processor is also configured to separate a plurality of voice signals from the audio input signal and determine an operating mode for an audio output signal. The processor is further configured to selectively adjust each of the plurality of voice signals based on the operating mode to generate the audio output signal.

In still another form, a non-transitory computer readable storage media is provided that is encoded with instructions that, when executed by a processor of computing device, cause the processor to obtain an audio input signal of a plurality of users in a physical location. The audio input signal is captured by a microphone. The instructions also cause the processor to separate a plurality of voice signals from the audio input signal and determine an operating mode for an audio output signal. The instructions further cause the processor to selectively adjust each of the plurality of voice signals based on the operating mode to generate the audio output signal.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims. For instance, the specific IEs described are used as examples of IEs that are currently defined in 3GPP specifications, but the techniques described herein may be adapted to other IEs that may be defined in current or future network specifications.

What is claimed is:

1. A method comprising:
obtaining an audio input signal of a plurality of users in a physical location, the audio input signal captured by a microphone;
separating a plurality of voice signals from the audio input signal;
determining an operating mode for an audio output signal; and
selectively adjusting each of the plurality of voice signals based on the operating mode to generate the audio output signal.

2. The method of claim 1, further comprising providing the audio output signal to a remote endpoint.

3. The method of claim 1, further comprising:
separating a background noise signal from the audio input signal; and
suppressing the background noise signal from the audio output signal.

4. The method of claim 1, wherein at least one of the plurality of voice signals includes audio signals from more than one of the plurality of users.

5. The method of claim 1, wherein separating a particular voice signal from the audio input signal is based on a reverberation level of the particular voice signal.

6. The method of claim 5, further comprising obtaining a video signal of the physical location, wherein separating the particular voice signal is further based on the video signal.

7. The method of claim 1, further comprising removing a reverberation from at least one of the plurality of voice signals.

8. The method of claim 1, wherein the operating mode is a single talker mode, the method further comprising:
selecting a primary voice signal among the plurality of voice signals; and
suppressing one or more secondary voice signals other than the primary voice signal from the audio output signal, the one or more secondary voice signals being among the plurality of voice signals separated from the audio input signal.

9. The method of claim 1, wherein the operating mode is a multi-talker mode, wherein selectively adjusting each of the plurality of voice signals comprises balancing an audio level of the plurality of voice signals to generate substantially equal contributions from each of the plurality of voice signals to the audio output signal.

10. The method of claim 1, further comprising obtaining another audio input signal from another microphone to assist in separating the plurality of voice signals.

11. A system comprising:
a microphone configured to capture audio;
a network interface configured to communicate with a plurality of devices in a network system; and
a processor coupled to the network interface and the microphone, the processor configured to:
obtain an audio input signal of a plurality of users in a physical location, the audio input signal captured by the microphone;
separate a plurality of voice signals from the audio input signal;
determine an operating mode for an audio output signal; and
selectively adjust each of the plurality of voice signals based on the operating mode to generate the audio output signal.

12. The system of claim 11, wherein the processor is further configured to cause the network interface to provide the audio output signal to a remote endpoint.

13. The system of claim 11, wherein the processor is configured to separate a particular voice signal from the audio input signal based on a reverberation level of the particular voice signal.

14. The system of claim 11, wherein the operating mode is a single talker mode, and wherein the processor is further configured to:
select a primary voice signal among the plurality of voice signals; and
suppress one or more secondary voice signals other than the primary voice signal from the audio output signal, the one or more secondary voice signals being among the plurality of voice signals separated from the audio input signal.

15. The system of claim 11, wherein the operating mode is a multi-talker mode, and wherein the processor is configured to selectively adjust each of the plurality of voice signals by balancing an audio level of the plurality of voice signals to generate substantially equal contributions from each of the plurality of voice signals to the audio output signal.

16. The system of claim 11, further comprising a Deep Neural Network (DNN) trained to enable the processor to separate the plurality of voice signals from the audio input signal, determine the operating mode for the audio output signal, or selectively adjust each of the plurality of voice signals.

17. One or more non-transitory computer readable storage media encoded with software comprising computer executable instructions and, when the software is executed on a processor of a computing device, operable to cause a processor to:
obtain an audio input signal of a plurality of users in a physical location, the audio input signal captured by a microphone;
separate a plurality of voice signals from the audio input signal;
determine an operating mode for an audio output signal; and
selectively adjust each of the plurality of voice signals based on the operating mode to generate the audio output signal.

18. The one or more non-transitory computer readable storage media of claim 17, wherein the software is further operable to cause the processor to provide the audio output signal to a remote endpoint.

19. The one or more non-transitory computer readable storage media of claim 17, wherein the operating mode is a single talker mode, and wherein the software is further operable to cause the processor to:
select a primary voice signal among the plurality of voice signals; and
suppress one or more secondary voice signals other than the primary voice signal from the audio output signal, the one or more secondary voice signals being among the plurality of voice signals separated from the audio input signal.

20. The one or more non-transitory computer readable storage media of claim 17, wherein the operating mode is a multi-talker mode, and wherein the software is further operable to cause the processor to selectively adjust each of the plurality of voice signals by balancing an audio level of the plurality of voice signals to generate substantially equal contributions from each of the plurality of voice signals to the audio output signal.
